(19) United States
(12) Patent Application Publication
(10) Pub. No.: US 2007/0181606 A1
(43) Pub. Date: Aug. 9, 2007

(54) Trigger sprayer with hand pad

(75) Inventor: Donald D. Foster, St. Charles, MO (US)

Correspondence Address: THOMPSON COBURN, LLP, ONE US BANK PLAZA, SUITE 3500, ST LOUIS, MO, 63101, US

(73) Assignee: Continental AFA Dispensing Company

(21) Appl. No.: 11/348,757

(22) Filed: Feb. 7, 2006

(51) Int. Cl. B67D 5/40

(52) U.S. Cl. 222/383.1

(57) ABSTRACT

A manually handheld and operated trigger sprayer has a novel shroud configuration that provides an aesthetically pleasing appearance to the component parts of the trigger sprayer and also provides a pad on the shroud that provides a comfortable feel to the user's hand holding the trigger sprayer in addition to enhancing the appearance of the trigger sprayer.

### BACKGROUND OF THE INVENTION

1. Field of the Invention

The present invention pertains to a trigger sprayer of the type that is manually held and operated to pump liquid from an attached bottle and dispense the liquid in a selected discharge pattern from the trigger sprayer. In particular, the present invention pertains to a trigger sprayer having an aesthetically appearing shroud and a pad on the shroud that comfortably engages with the user's hand in the area between the thumb and forefinger.

2. Description of the Related Art

Handheld and hand pumped liquid dispensers known as trigger sprayers are used to dispense liquid products used in the home and in industry. Trigger sprayers have been used in the home to dispense household cleaning or cooking liquids. Additionally, trigger sprayers have been used in industry to dispense cleaning liquids. The trigger sprayer is typically connected to a bottle containing the liquid dispensed by the trigger sprayer.

The typical construction of a trigger sprayer includes a sprayer housing that is connected to the neck a bottle by either a threaded connection or a bayonet-type connection. The sprayer housing is formed with a pump chamber and a vent chamber, a liquid supply passage that communicates the pump chamber with a liquid inlet opening of the sprayer housing, and a liquid discharge passage that communicates the pump chamber with a liquid outlet opening of the sprayer housing. A dip tube is connected to the sprayer housing at the liquid inlet opening and communicates the pump chamber with the liquid contents of the bottle connected to the trigger sprayer.

A nozzle assembly is connected to the sprayer housing at the liquid outlet opening. Some nozzle assemblies include features that enable the adjustment of the liquid discharged from the trigger sprayer. The nozzle assembly can be adjusted between an “off” position where discharge from the trigger sprayer is prevented, and one or more “on” positions where liquid discharge from the trigger sprayer is permitted, and the discharge can be in a spray, stream, or foam pattern of discharge.

A trigger is mounted on the sprayer housing for movement of the trigger relative to the sprayer housing. Typically the trigger pivots relative to the sprayer housing, however other types of movements are possible. The trigger is operatively connected to a pump of the sprayer housing to cause operation of the pump in response to the movement of the trigger on the sprayer housing. A spring is often operatively connected to the trigger to resist the movement of the trigger when pumping liquid from the pump. A user's hand squeezes the trigger toward the trigger sprayer to operate the pump and discharge liquid from the trigger sprayer. Releasing the trigger causes the spring to push the trigger away from the sprayer housing, thus causing the pump to draw liquid from the bottle into the pump chamber. Trigger sprayers of the prior art have employed various different types of pumps, i.e. piston/cylinder pumps, bulb pumps, etc.

Inlet and outlet check valves are assembled into the respective liquid supply passage and liquid discharge passage of the sprayer housing. The check valves control the flow of liquid from the bottle through the liquid supply passage and into the pump chamber, and then from the pump chamber and through the liquid discharge passage to the nozzle assembly of the trigger sprayer.

Because trigger sprayers are often visible at their point of purchase, it is important that trigger sprayers have a desirable appearance to attract consumers. Trigger sprayers have been provided with aesthetically designed shrouds that attach to the sprayer housing. The shrouds cover over much of the sprayer housing, concealing the functional appearance of the liquid discharge passage, the pump chamber, and vent chamber of the sprayer housing. Thus, the typical shroud provides an aesthetically pleasing appearance to the trigger sprayer.

In addition to the aesthetically pleasing appearance of a trigger sprayer, it is desirable that the trigger sprayer be comfortable to use. Various different trigger configurations and shroud configurations have been designed to comfortably fit in the hand of a user of the trigger sprayer.

### SUMMARY OF THE INVENTION

The present invention pertains to a novel construction of a trigger sprayer that has enhanced the comfort of holding the trigger sprayer in the hand. The trigger sprayer of the invention is provided with a shroud having a novel configuration that comfortably fits between the thumb and forefinger of a user's hand, and a pad provided on the shroud that provides a comfortable feel to the user's hand gripping the trigger sprayer.

Much of the construction of the trigger sprayer, apart from the novel shroud construction, is conventional. The novel shroud construction of the invention is intended for use with the various known types of manually operated trigger sprayers, and the particular construction of the trigger sprayer on which the shroud is mounted is illustrative only and is not intended to be limiting. Because the novel shroud of the invention may be employed on various different types of trigger sprayers, the component parts of the trigger sprayer are described only generally herein.

The trigger sprayer includes a sprayer housing that contains the pump chamber of the manually operated pump of the trigger sprayer. A liquid inlet opening is provided on the sprayer housing and a liquid supply passage communicates the liquid inlet opening with the pump. A liquid outlet opening is also provided on the sprayer housing and a liquid discharge passage communicates the pump with the liquid outlet opening. On operation of the pump, liquid is drawn through the liquid inlet opening and the liquid supply passage to the pump, and then is discharged from the pump through the liquid discharge passage and the liquid outlet opening, as is conventional.

The sprayer housing contains a vent chamber adjacent the pump chamber. The vent chamber is operable to vent the interior of the bottle connected to the trigger sprayer to the exterior environment on operation of the pump.

A connector cap is provided on the sprayer housing for attaching the trigger sprayer to a bottle containing the liquid to be dispensed by the trigger sprayer. The connector cap can have a threaded fitment or a bayonet-type fitment. The cap could also be integrally formed with the sprayer housing, or could be mounted on the sprayer housing for rotation relative to the sprayer housing.

A dip tube is assembled to the sprayer housing at the liquid inlet opening. When the sprayer housing is attached to a bottle, the dip tube is inserted through the opening of the bottle and into the liquid of the bottle, thereby communicating the liquid with the pump of the trigger sprayer.

An input valve is assembled in the liquid supply passage and an output valve is assembled in the liquid discharge passage. The input valve controls the flow of liquid from the sprayer housing inlet opening to the pump, and the output valve controls the flow of liquid from the pump and through the liquid discharge passage to the liquid outlet opening.

A nozzle assembly is assembled to the trigger sprayer at the liquid outlet opening. The nozzle assembly is rotatable relative to the trigger sprayer to adjust the liquid discharge of the trigger sprayer between “off,” “spray,” and “stream” liquid discharge patterns. Alternatively, the nozzle assembly could also provide a foam discharge of the liquid from the trigger sprayer.

A piston assembly is mounted in the pump chamber of the sprayer housing for reciprocating movements between charge and discharge positions of the piston assembly relative to the sprayer housing. The piston assembly includes a pump piston and a vent piston. The vent piston is received inside the vent chamber of the sprayer housing. As the pump piston is moved to its charge position in the pump, the interior volume of the pump is increased and a vacuum is created. The vacuum draws liquid into the pump through the dip tube, the liquid inlet opening, and the liquid supply passage. As the pump piston is moved to its charge position, the vent piston is moved in the vent chamber to a closed position where a vent air flow path through the vent chamber to the interior of the bottle connected to the trigger sprayer is closed. When the pump piston is moved to its discharge position in the pump, the interior volume of the pump is reduced. This causes the liquid in the pump to be pumped out of the pump and through the liquid discharge passage and the liquid outlet opening of the sprayer housing. As the pump piston is moved to its discharge position, the vent piston is moved to an open position in the vent chamber. This opens the vent air flow path through the vent chamber and into the interior volume of the bottle attached to the trigger sprayer.

A manually operated trigger is mounted on the sprayer housing for pivoting movement. The trigger pivots in a forward direction away from the sprayer housing and a rearward direction toward the sprayer housing. The pump piston and vent piston are operatively connected to the trigger for movement in response to movement of the trigger. The movement of the trigger in the rearward direction causes the pump piston to move to its discharge position in the pump chamber and causes the vent piston to move to its open position in the vent chamber. Releasing the trigger causes a spring in the pump chamber to move the pump piston and the trigger in the forward direction away from the sprayer housing.

The novel shroud of the invention is attached to the sprayer housing. The configuration of the shroud includes a top wall, a rear wall, and a pair of opposite side walls that surround the sprayer housing. The shroud covers over the liquid supply passage, the liquid discharge passage, the pump chamber, and the vent chamber of the sprayer housing, thereby providing an aesthetically pleasing appearance to the trigger sprayer.

The configuration of the shroud also provides functional comfort features to the trigger sprayer. In one embodiment, as the shroud rear wall and side walls extend downwardly from the shroud top wall, they gradually extend rearwardly away from the sprayer housing. The shroud rear wall and side walls then curve sharply inwardly toward each other, forming a bottom surface on the underside of the shroud that projects rearwardly from the sprayer housing. The shroud bottom surface is positioned to rest on the user's hand when the user is holding and operating the trigger sprayer. The bottom surface is positioned at the rear of the shroud to rest on a portion of the user's hand between the thumb and forefinger of the hand. This comfortably suspends the trigger sprayer and the bottle attached to the trigger sprayer on the user's hand.

In an additional embodiment, as the shroud rear wall and side walls extend downwardly from the shroud top wall, they all curve outwardly away from the sprayer housing. The shroud rear wall and side walls continue to extend downwardly and outwardly from the sprayer housing, and then curve sharply inwardly toward the sprayer housing. This produces an outwardly projecting ledge on the sprayer housing that has an underside positioned at the opposite sides of the sprayer housing and at the rear of the sprayer housing. The shroud underside has a general U-shape and is positioned to rest on the user's hand when the user is holding and operating the trigger sprayer. Specifically, the U-shaped ledge underside rests on a portion of the user's thumb, the user's forefinger, and the portion of the user's hand that extends between the thumb and forefinger. This also comfortably suspends the trigger sprayer and the bottle attached to the trigger sprayer on the user's hand.

In additional embodiments, a pad is provided on the shroud rear wall and the shroud side walls. The pad extends from a bottom edge of the shroud upwardly across the shroud rear wall and side walls. The pad is positioned beneath the shroud bottom surface and beneath the ledge underside of the two previously described embodiments of the shroud. In the variant embodiments of the invention, the pad is constructed of a material that is more resilient than the material of the shroud, thereby functioning as a cushion that engages with the user's hand in an area of the hand between the thumb and forefinger. In other embodiments, the pad has a tactile surface or a textured surface that is different from the surface of the shroud to provide a comfortable feel to the user's hand holding the trigger sprayer. Still further, in the above-described variant embodiments, the pad is constructed of a different color material from the color material of the shroud, enhancing the aesthetically pleasing appearance of the shroud.

### DESCRIPTION OF THE DRAWING FIGURES

Further features of the invention are set forth in the following detailed description of the preferred embodiments of the invention and in the drawing figures wherein:

FIG. 1 is a side view, in section, of a first embodiment of the trigger sprayer shroud showing the component parts of the trigger sprayer example on which the shroud is attached;

FIG. 2 is a front perspective view of the shroud of FIG. 1;

FIG. 3 is a rear perspective view of the shroud of FIG. 1;

FIG. 4 is a front perspective view of a further embodiment of the shroud;

FIG. 5 is a rear perspective view of the shroud of FIG. 4;

FIG. 6 is a front perspective view of a further embodiment of the shroud; and,

FIG. 7 is a rear perspective view of the shroud of FIG. 6.

### DETAILED DESCRIPTION OF THE PREFERRED EMBODIMENT

As stated earlier, the present invention pertains to a novel construction of a trigger sprayer that enhances the comfort to the hand of a user holding the trigger sprayer. The novel features of the trigger sprayer are provided in a shroud of the trigger sprayer that has a novel configuration that comfortably fits between the thumb and forefinger of a user's hand, and a pad connected to the shroud that provides a comfortable feel to the user's hand gripping the trigger sprayer. Much of the construction of the trigger sprayer, apart from the novel construction of the shroud, is conventional. The novel shroud construction is intended for use with the various known types of manually operated trigger sprayers, and the particular construction of the trigger sprayer on which the shroud is mounted is illustrative only, and is not intended to be limiting. Because the novel construction of the shroud may be employed on various different types of trigger sprayers, the component parts of the trigger sprayer are described only generally herein.

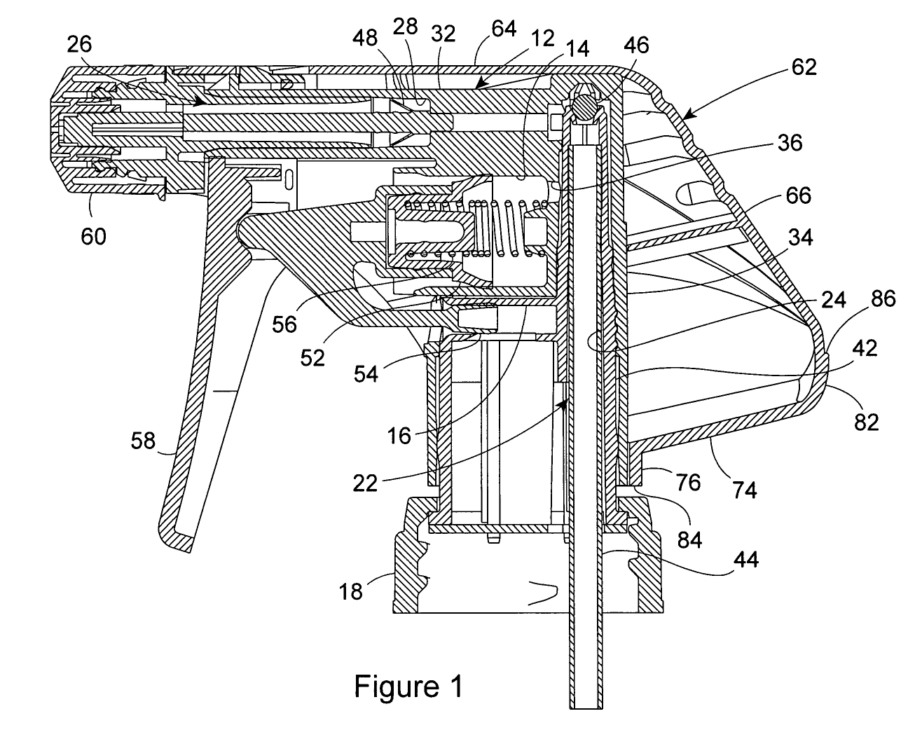

FIG. 1 shows a cross-section view of the construction of a typical hand-operated trigger sprayer on which the novel shroud of the invention may be used. The construction of the trigger sprayer is similar to that of U.S. Pat. No. 5,344,053, which is incorporated herein by reference. The trigger sprayer includes a sprayer housing 12 having a two-piece construction that contains a pump having a cylindrical pump chamber 14, and a vent having a cylindrical vent chamber 16. A connector cap 18 is provided to connect the sprayer housing 12 to the neck of a separate bottle containing the liquid to be dispensed by the trigger sprayer. The connector cap 18 can be an integral part of the sprayer housing 12, or can be mounted for rotation on the sprayer housing as shown. A liquid inlet opening 22 is provided in the sprayer housing 12. The liquid inlet opening 22 communicates with a liquid supply passage 24 that extends from the inlet opening to the pump chamber 14. The sprayer housing is also provided with a liquid outlet opening 26. The liquid outlet opening 26 communicates through a liquid discharge passage 28 of the sprayer housing with the pump chamber 14.

The orientation of the sprayer housing 12 shown in FIG. 1 is the typical orientation of the sprayer housing when the trigger sprayer is being used. In the orientation shown, the forward direction of liquid discharge from the sprayer housing 12 is to the left, and the opposite rearward direction is to the right. The sprayer housing top surface 32 faces upwardly, and the liquid inlet opening 22 faces in the opposite downward direction. The liquid outlet opening 26 faces in the forward direction, and the sprayer housing rear surface 34 faces in the opposite rearward direction.

The pump chamber 14 has an opening 36 that communicates the pump chamber with the liquid supply passage 24, and communicates the pump chamber with the liquid discharge passage 28.

The two piece sprayer housing has a dip tube connector 42 that extends upwardly from the liquid inlet opening 22. The dip tube connector 42 has a lower portion that connects a dip tube 44 with the sprayer housing 12. The dip tube connector 42 also has an upper portion that functions as an input valve seat.

A ball valve 46 sits on top of the upper portion of the dip tube connector 42 that functions as the input valve seat. The ball valve 46 controls the flow of liquid through the dip tube 44 and the sprayer housing inlet opening 22 to the pump chamber 14. A flexible disk valve or cone shaped valve 48 is positioned in the liquid discharge passage 28. The disk valve 48 controls the flow of liquid from the pump chamber 14 through the liquid discharge passage 28 to the liquid outlet opening 26.

A pump piston 52 is mounted in the pump chamber 14 for reciprocating forward and rearward movements between charge and discharge positions of the pump piston in the pump chamber. When moved forwardly to the charge position, the pump piston 52 draws liquid into the pump chamber 14. When moved rearwardly to the discharge position, the pump piston 52 pumps the liquid from the pump chamber 14.

A vent piston 54 is connected to the pump piston 52 for reciprocating movements with the pump piston. The vent piston 54 is mounted in the vent chamber 16 for reciprocating movements between vent open and vent closed positions. In the vent open position, the interior of the bottle connected to the trigger sprayer is vented through the vent chamber 16 to the exterior environment of the sprayer housing 12. When the pump piston 52 is moved rearwardly or in the rearward direction in the pump chamber 14 toward the discharge position, the vent piston 54 is also moved in the rearward direction in the vent chamber 16 toward the open vent position. When the pump piston 52 is moved forwardly or in the forward direction in the pump chamber 14 toward the charge position, the vent piston 52 is also moved forwardly in the vent chamber to the vent closed position.

A coil spring 56 is positioned in the pump chamber 14 and engages against the pump piston 52. The spring biases the pump piston in the forward direction toward the charge position of the piston relative to the pump chamber 14. Thus, the spring also biases the vent piston 54 in the forward direction toward the vent closed position.

A trigger 58 is mounted on the sprayer housing 12 for pivoting movement of the trigger relative to the sprayer housing. The trigger 58 is operatively connected to the pump piston 52 and the vent piston 54. Movement of the trigger 58 on the sprayer housing 12 by a user's hand holding the trigger sprayer results in the reciprocating movements of the pump piston 52 and the vent piston 54 in the respective pump chamber 14 and vent chamber 16.

An indexing nozzle 60 is mounted on the sprayer housing 12 at the liquid outlet opening 26. The nozzle 60 can be turned on the sprayer housing 12 to selectively prevent and permit liquid discharge from the sprayer housing. In addition, the indexing nozzle 60 can be rotated to various positions of the nozzle relative to the sprayer housing 12 where the spray pattern of liquid discharged from the sprayer housing is changed between a spray, stream, and foam discharge pattern.

The construction of the trigger sprayer set forth above is typical, and is only one example of the construction of the various known types of trigger sprayers. As stated earlier, the particular construction of the trigger sprayer described herein is intended to be illustrative only, and is not intended to limit the use of the novel shroud of the invention to any one particular type of trigger sprayer construction.

Several embodiments of the shroud of the present invention are shown assembled to the exterior of the trigger sprayer housing 12 in the drawing figures. The shroud embodiments provide an aesthetically pleasing appearance to the exterior of the sprayer housing 12, and also provide a comfortable hand hold of the trigger sprayer.

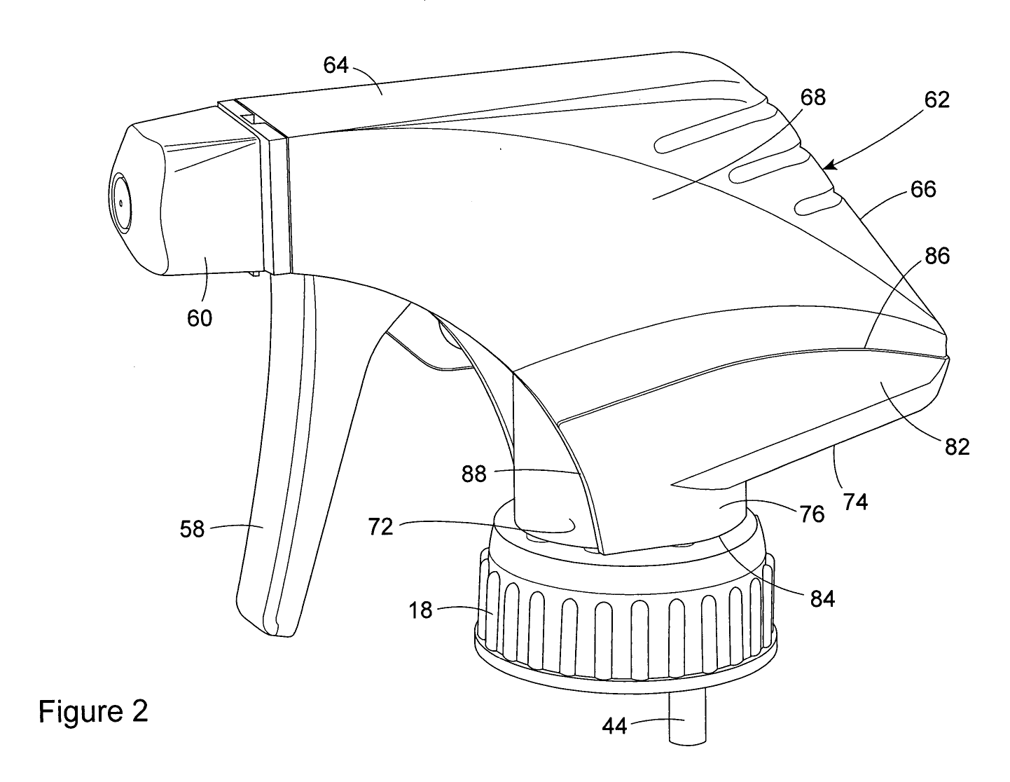

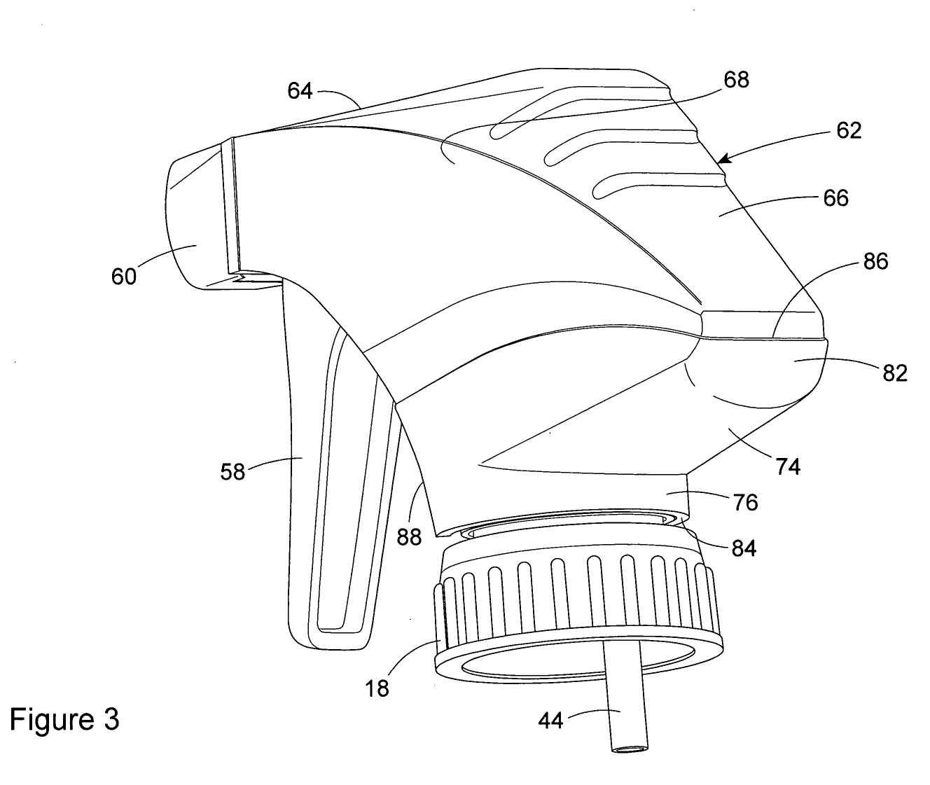

In the embodiment of the shroud 62 shown in FIGS. 1-3, the shroud has a configuration that includes a top wall 64 that covers over the sprayer housing top surface 32, a rear wall 66 that covers over the sprayer housing rear surface 34, and opposite side walls 68 that cover over the opposite side surfaces 72 of the sprayer housing, a portion of which is shown in FIG. 2. Thus, the shroud 62 conceals from view the liquid supply passage 24, the liquid discharge passage 28, the pump chamber 14, and the vent chamber 16 of the sprayer housing 12, thereby providing the trigger sprayer with an aesthetically pleasing appearance.

The configuration of the shroud 62 also provides functional comfort features to the trigger sprayer. As shown in FIGS. 1-3, as the shroud rear wall 66 and side walls 68 extend downwardly from the shroud top wall 64, the rear wall 66 bows or curves outwardly away from the trigger sprayer housing 12, and the side walls 68 extend rearwardly with the shroud rear wall 66. The shroud rear wall 66 and side walls 68 then all curve sharply inwardly toward each other as they continue to extend downwardly from the shroud top wall 64. This defines a projecting bottom surface 74 on the underside the shroud. The shroud underside or bottom surface 74 faces downwardly and extends rearwardly from the sprayer housing rear surface 34. The bottom surface 74 is positioned on the shroud 62 to rest comfortably on top of a user's hand between the thumb and forefinger of the user's hand when the trigger sprayer is in use. This comfortably suspends the trigger sprayer and the bottle attached to the trigger sprayer on the top of the user's hand. From the shroud bottom surface 74, the shroud continues to extend downwardly across lower portions of the sprayer housing side surfaces 72 and the sprayer housing rear surface 34, providing a smooth convex surface 76 for gripping in the hand between the thumb and forefinger.

In addition, a pad 82 is provided on the shroud exterior on portions of the shroud rear wall 66 and side walls 68. The pad 82 is sensory distinguishable from the remainder of the shroud 62, meaning that the pad 82 is visually different than the remainder of the exterior of the shroud 62 and/or the pad 82 is different to the touch than the remainder of the exterior of the shroud 62. The pad 82 is positioned on the shroud rear wall 66 adjacent the shroud bottom edge 84 and extends upwardly across the shroud rear wall and across the underside or bottom surface 74 of the shroud to a top edge 86 of the pad. In addition, the width of the pad 82 extends around the convex surface 76 at the bottom of the shroud 62 and across portions of the shroud side walls 68 to a forward edge 88 of the pad. This positioning of the pad 82 allows the pad to engage the hand of a user of the trigger sprayer between the thumb and forefinger of the hand, and to engage on top of the portion of the user's hand between the thumb and forefinger. In variant embodiments, the pad 82 is constructed of a different material from that of the shroud 62. For example, the pad 82 may be constructed of a material that is more resilient or is softer to the touch than the material of the shroud 62. This embodiment of the pad functions as a cushion that engages the user's hand in the area of the hand between the thumb and forefinger. In other embodiments, the pad 82 has a tactile or textured exterior surface that is different to the touch from the exterior surface of the shroud 62 to provide a comfortable feel to the user's hand holding the trigger sprayer. Still further, in the above-described variant embodiments, the pad 82 is constructed of a different color material from the color material of the shroud 62, enhancing the aesthetically pleasing appearance of the shroud.

The pad 82 can be a separate piece that is secured to the exterior surface of the shroud 62 by adhesives or other equivalent means. Preferably, the pad 82 and shroud 62 are manufactured using a two-material injection molding process, or a multi-shot molding process where the majority of the shroud 62 is injection molded, and then transferred to a different mold cavity where the pad 82 is injection molded using a different material.

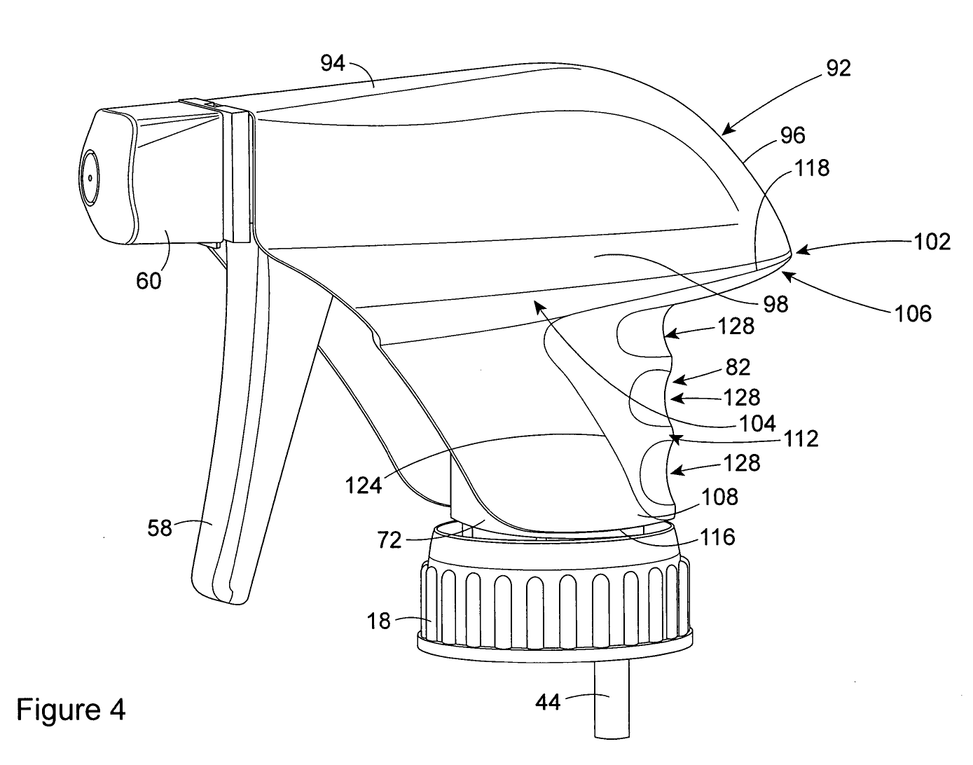

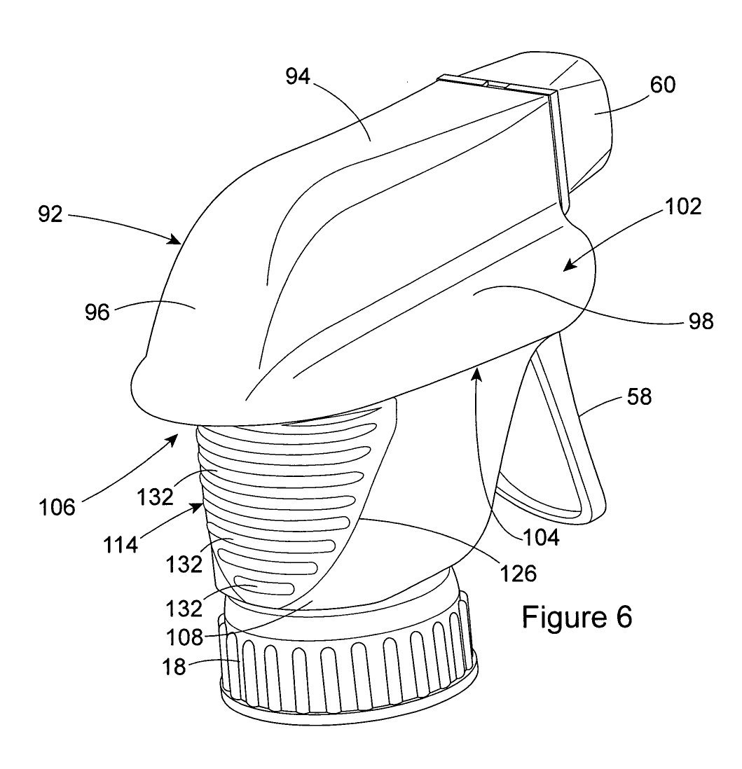

FIGS. 4-7 show further embodiments of the trigger sprayer shroud and pad. These embodiments of the shroud are also assembled to the exterior of the trigger sprayer housing 12. They also provide the trigger sprayer with an aesthetically pleasing appearance, and provide a comfortable handhold of the trigger sprayer. The shroud 92 shown in FIGS. 4-7 has the same configuration in each of the figures. The shroud configuration includes a top wall 94 that covers over the sprayer housing top surface 32, a rear wall 96 that covers over the sprayer housing rear surface 34, and opposite side surfaces 98 that cover over the opposite sprayer housing side wall 72, portions of which are shown in FIGS. 4 and 6. Thus, the shroud 92 conceals from view the liquid supply passage 24, the liquid discharge passage 28, the pump chamber 14, and the vent chamber 16 of the sprayer housing 12, thereby providing an aesthetically pleasing appearance to the trigger sprayer.

The shroud configuration also provides functional comfort features to the trigger sprayer. As shown in FIGS. 4-7, as the shroud rear wall 96 and side walls 98 extend downwardly from the top wall 94, they all bow or curve outwardly away from the trigger sprayer housing 12. The shroud rear wall 96 and side walls 98 then curve sharply inwardly as they continue to extend downwardly from the shroud top wall 94, defining a projecting ledge 102 that extends across the opposite side walls 98 and across the rear wall 96 of the shroud. The ledge 102 has bottom surface or underside areas 104 that are positioned beneath the portions of the ledge 102 that project outwardly from the shroud side walls 98. The ledge also has a bottom surface or underside area 106 that is positioned beneath the portion of the ledge 102 that projects outwardly from the shroud rear wall 96. The ledge underside areas 104, 106 are positioned to rest comfortably on top of the thumb, forefinger, and the portion of a user's hand between the thumb and forefinger. This comfortably suspends the trigger sprayer and the bottle attached to the trigger sprayer on the user's hand. Beneath the ledge underside areas 104, 106 the shroud side walls 98 and rear wall 96 form a smooth convex surface 108 for gripping in the hand between the thumb and forefinger.

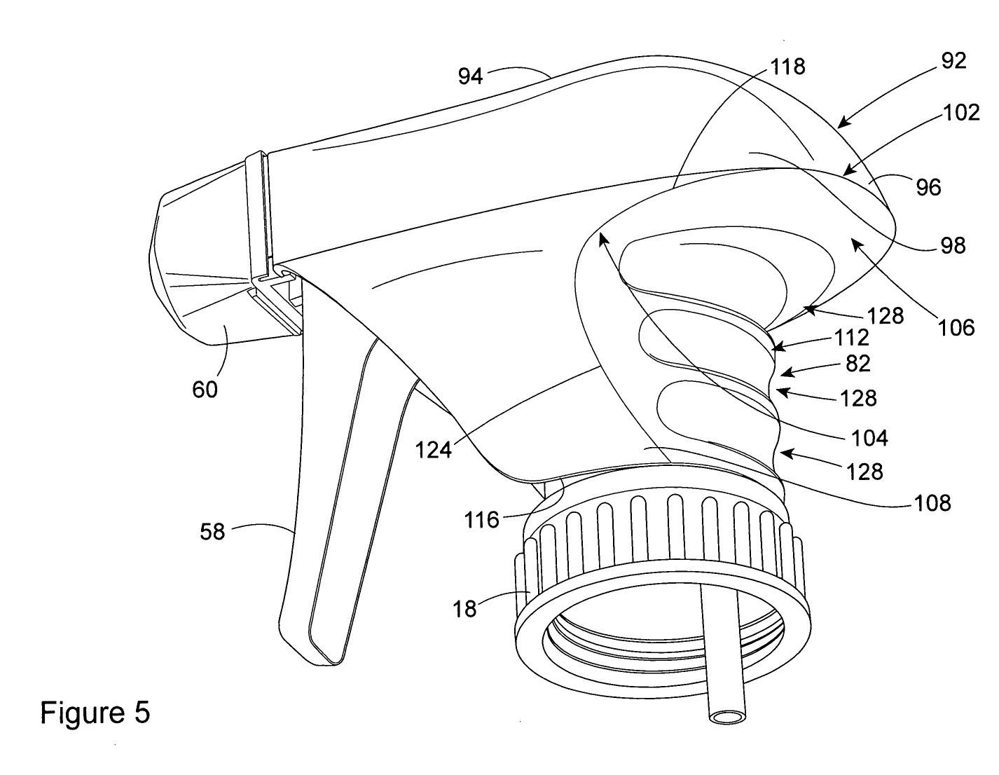

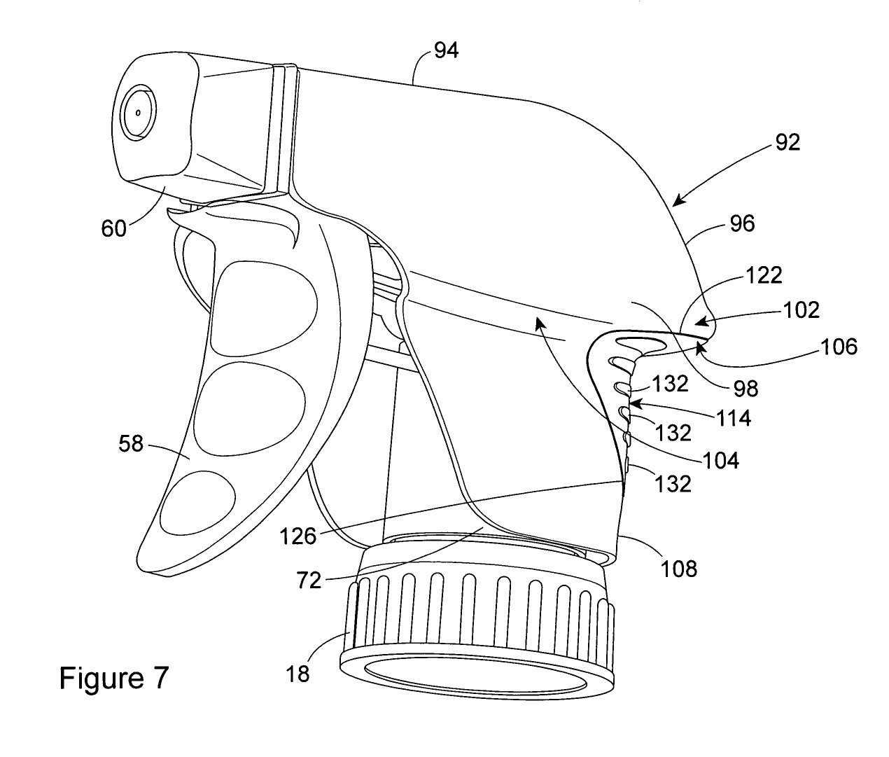

In addition, different embodiments of a pad 112, 114 are provided on the shroud of FIGS. 4-7. Each pad 112, 114 is sensory distinguishable from the remainder of the shroud 92, meaning that the pad 112, 114 is visually different than the remainder of the shroud 92 and/or the pad 112, 114 is different to the touch than the remainder of the shroud 92. Each pad 112, 114 is positioned on the shroud rear wall 96 adjacent the shroud bottom edge 116 and extends upwardly across the shroud rear wall and across the underside 106 of the rear wall ledge portion to a top edge 118, 122 of the pads. In addition, the width of the pad 112, 114 extends around the shroud and across portions of the shroud convex surface 108, to a forward edge 124, 126 of the pad, and across portions of the ledge underside areas 104 on the side walls of the shroud. This positioning of the pad 112, 114 causes the pad to engage the hand of a user of the trigger sprayer between the thumb and forefinger of the hand. In variant embodiments, the pad 112, 114 is constructed of a material that is more resilient or softer to the touch than the material of the shroud 92, thereby functioning as a cushion that engages the user's hand in the area between the thumb and forefinger. In other embodiments, the pad 112, 114 has a tactile or textured exterior surface that is different to the touch from the exterior surface of the shroud 92 to provide a comfortable feel to the user's hand holding the trigger sprayer. The textured surface could include grooves 128 such as those shown in FIGS. 4 and 5, or ribs 132 such as those shown in FIGS. 6 and 7. Still further, in the above-described variant embodiments, the pad 112, 114 is constructed of a different color material from the color material of the shroud 92, enhancing the aesthetically pleasing appearance of the shroud.

Although the trigger sprayer of the invention has been described above by reference to a particular embodiments of the trigger sprayer, and to particular embodiments of the shroud, it should be understood that variations and modifications could be made to the invention without departing from the intended scope of the following claims.

1) A trigger sprayer that is manually held and operated to pump liquid from a bottle connected to the trigger sprayer and dispense the liquid from the trigger sprayer, the trigger sprayer comprising:
a sprayer housing containing a manually operated pump, a liquid inlet opening positioned on the sprayer housing to receive liquid from a bottle connected to the sprayer housing, a liquid supply passage in the sprayer housing communicating the liquid inlet opening with the pump to direct liquid from the inlet opening to the pump on operation of the pump, a liquid outlet opening positioned on the sprayer housing to discharge liquid from the sprayer housing, and a liquid discharge passage in the sprayer housing communicating the pump with the liquid outlet opening to direct liquid from the pump to the liquid outlet opening on operation of the pump;
a trigger mounted on the sprayer housing for manually engaging and moving the trigger relative to the sprayer housing, the trigger being operatively connected to the pump to operate the pump in response to manual movement of the trigger;
a shroud mounted on the sprayer housing covering over a top surface, opposite side surfaces and covering over a rear surface of the sprayer housing that is opposite the trigger; and,
a pad positioned on the shroud where the pad is engaged by a user's hand that is manually holding the trigger sprayer and is manually engaging and moving the trigger relative to the sprayer housing, the pad and the shroud being sensory distinguishable.

2) The trigger sprayer of claim 1, further comprising:
the shroud and the pad being different colors and thereby being visually distinguishable.

3) The trigger sprayer of claim 1, further comprising:
the shroud having a first exterior surface texture and the pad having a second exterior surface texture that is different from the first exterior surface texture.

4) The trigger sprayer of claim 1, further comprising:
the shroud being constructed of a first material and the pad being constructed of a second material that is different from the first material.

5) The trigger sprayer of claim 1, further comprising:
the shroud and the pad being constructed of two separate pieces of material that are connected together.

6) The trigger sprayer of claim 1, further comprising:
the pad being positioned on the shroud rear surface.

7) The trigger sprayer of claim 6, further comprising:
the pad curving around the shroud rear surface with portions of the pad extending over the shroud side surfaces.

8) The trigger sprayer of claim 1, further comprising:
the shroud having a ledge that projects outwardly from the shroud rear surface and the shroud side surfaces; and,
the pad having a portion that is mounted on the ledge where the pad portion extends over a user's hand holding the trigger sprayer.

9) The trigger sprayer of claim 1, further comprising:
the pad being mounted on the shroud in a position to engage with a user's hand between a thumb and forefinger when the user's hand is manually holding the trigger sprayer and is manually engaging and moving the trigger relative to the sprayer housing.

10) A trigger sprayer that is manually held and operated to pump liquid from a bottle connected to the trigger sprayer and dispense the liquid from the trigger sprayer, the trigger sprayer comprising:
a sprayer housing containing a manually operated pump, a liquid inlet opening positioned on the sprayer housing to receive liquid from a bottle connected to the trigger sprayer, a liquid supply passage in the sprayer housing communicating the liquid inlet opening with the pump to direct liquid from the liquid inlet opening to the pump on operation of the pump, a liquid outlet opening positioned on the sprayer housing to discharge liquid from the sprayer housing in a forward direction relative to the sprayer housing, a liquid discharge passage in the sprayer housing communicating the pump with the liquid outlet opening, the sprayer housing having an external top surface that faces in an upward direction, an external rear surface that faces in a rearward direction that is opposite the forward direction, and a pair of external side surfaces that face away from each other in opposite side directions;
a trigger mounted on the sprayer housing for manually engaging and moving the trigger relative to the sprayer housing, the trigger being operatively connected to the pump to operate the pump in response to manual movements of the trigger;
a shroud mounted on the sprayer housing, the shroud covering over the top surface, the rear surface, and the opposite side surfaces of the sprayer housing; and,
a pad on the shroud, the pad having an external surface that faces in the rearward direction from the shroud.

11) The trigger sprayer of claim 10, further comprising:
the shroud being constructed of a first material; and,
the pad being constructed of a second material that is different from the shroud first material.

12) The trigger sprayer of claim 11, further comprising:
the pad second material being more resilient than the shroud first material.

13) The trigger sprayer of claim 10, further comprising:
the shroud and the pad being different colors, distinguishing the pad from the shroud.

14) The trigger sprayer of claim 10, further comprising:
the shroud having a first exterior surface texture and the pad having a second exterior surface texture that is different from the first exterior surface texture.

15) The trigger sprayer of claim 10, further comprising:
the shroud having a first resilience and the pad having a second resilience that is different from the first resilience.

16) The trigger sprayer of claim 10, further comprising:
the shroud and the pad being constructed of two separate pieces of material that are connected together.

17) The trigger sprayer of claim 10, further comprising:
the pad curving around the shroud rear surface with portions of the pad extending over the shroud side surfaces.

18) The trigger sprayer of claim 10, further comprising:
the shroud having a ledge that projects outwardly from the shroud rear surface and the shroud side surfaces; and,
the pad having a portion that is mounted on the ledge where the pad portion extends over a user's hand holding the trigger sprayer.

19) The trigger sprayer of claim 10, further comprising:
the pad being mounted on the shroud in a position to engage with a user's hand between a thumb and forefinger when the user's hand is manually holding the trigger sprayer and is manually engaging and moving the trigger relative to the sprayer housing.

20) The trigger sprayer of claim 10, further comprising:
the shroud having a pair of side walls that cover over the opposite side surfaces of the sprayer housing and a rear wall that covers over the rear surface of the sprayer housing, the shroud side walls being positioned to be gripped between a thumb and forefinger of a user's hand holding the trigger sprayer and the shroud rear wall being positioned to oppose the user's hand between the thumb and forefinger.

21) The trigger sprayer of claim 20, further comprising:
the pad being on the shroud rear wall.

22) A trigger sprayer that is manually held and operated to pump liquid from a bottle connected to the trigger sprayer and dispense the liquid in a forward direction from the trigger sprayer, the trigger sprayer comprising:
a sprayer housing containing a manually operated pump, a liquid inlet opening positioned on the sprayer housing to receive liquid from a bottle connected to the trigger sprayer, a liquid supply passage in the sprayer housing communicating the liquid inlet opening with the pump to direct liquid from the liquid inlet opening to the pump on operation of the pump, a liquid outlet opening positioned on the sprayer housing to discharge liquid from the sprayer housing in the forward direction; and a liquid discharge passage in the sprayer housing communicating the pump with the liquid outlet opening to direct liquid from the pump to the liquid outlet opening on operation of the pump;
a trigger mounted on the sprayer housing for movement in the forward direction and movement in an opposite rearward direction relative to the trigger sprayer in response to manual manipulation of the trigger by a user's hand holding the trigger sprayer, the trigger being operatively connected to the pump to operate the pump in response to movement of the trigger in the forward direction and the rearward direction;
a shroud mounted on the sprayer housing, the shroud having a top wall that covers over a top surface of the sprayer housing, a rear wall that extends downwardly from the top wall and covers over a rear surface of the sprayer housing, and a pair of side walls that extend downwardly from the top wall and cover over opposite side surfaces of the sprayer housing, the pair of side walls extending outwardly away from the sprayer housing and then extending inwardly toward the sprayer housing as the side walls extend downwardly from the top wall, thereby forming a projecting ledge that extends across the opposite side walls of the shroud, the ledge being positioned on the shroud to engage over a thumb and forefinger of a user's hand holding the trigger sprayer; and,
a pad positioned on the shroud to engage the user's hand holding the trigger sprayer.

23) The trigger sprayer of claim 22, further comprising:
the ledge extending in the forward and rearward directions across the opposite side walls of the shroud.

24) The trigger sprayer of claim 23, further comprising:
the ledge extending between the opposite shroud side walls and across the shroud rear wall.

25) The trigger sprayer of claim 22, further comprising:
the ledge having an underside that rests on the user's hand holding the trigger sprayer; and,
the pad extending across the ledge underside.

26) The trigger sprayer of claim 25, further comprising:
the ledge extending in the forward and rearward directions across the opposite side walls of the shroud and between the opposite side walls of the shroud around the rear wall of the shroud.

27) The trigger sprayer of claim 26, further comprising:
the pad being positioned on the rear wall of the shroud and on the ledge underside.

28) The trigger sprayer of claim 22, further comprising:
the shroud and the pad being different colors and thereby being visually distinguishable.

29) The trigger sprayer of claim 22, further comprising:
the shroud having a first exterior surface texture and the pad having a second exterior surface texture that is different from the first exterior surface texture.

30) The trigger sprayer of claim 22, further comprising:
the shroud being constructed of a first material and the pad being constructed of a second material that is different from the first material.

31) The trigger sprayer of claim 22, further comprising:
the shroud and the pad being constructed of two separate pieces of material that are connected together.

32) The trigger sprayer of claim 22, further comprising:
the pad being positioned entirely beneath the ledge.

33) The trigger sprayer of claim 22, further comprising:
the pad being mounted on the shroud rear wall beneath the ledge.
